(19) United States
(12) Patent Application Publication
(10) Pub. No.: US 2012/0291746 A1
(43) Pub. Date: Nov. 22, 2012

(54) CYLINDER BLOCK FOR AN INTERNAL COMBUSTION ENGINE AND AN INTERNAL COMBUSTION ENGINE

(75) Inventors: Paul BREIDENBACH, Bechenheim (DE); Torsten LOEHNERT, Liederbach (DE)

(73) Assignee: GM GLOBAL TECHNOLOGY OPERATIONS LLC, Detroit, MI (US)

(21) Appl. No.: 13/472,782

(22) Filed: May 16, 2012

(30) Foreign Application Priority Data
May 17, 2011 (DE) 10 2011 101 705.8

(51) Int. Cl. F02F 7/00

(52) U.S. Cl. 123/195 R

(57) ABSTRACT

A cylinder block for an internal combustion engine is provided. The cylinder block has a cylinder block housing and a crankcase. Upper plain bearing halves are arranged in the cylinder block housing toward a lower side of the cylinder block housing and lower plain bearing halves are arranged in a bearing frame toward an upper side of the crankcase. A partition plane is between the cylinder block housing and the crankcase. The upper plain bearing halves have a partition plane to the lower plain bearing halves, which aligns with the partition plane between the cylinder block housing and the crankcase. A bearing frame on both sides of the lower plain bearing halves has projections protruding beyond the partition plane. The projections protrude into recesses on the lower side of the cylinder block housing.

### CROSS-REFERENCE TO RELATED APPLICATION

This application claims priority to German Patent Application No. 10 2011 101 705.8, filed May 17, 2011, which is incorporated herein by reference in its entirety.

### TECHNICAL FIELD

The technical field generally relates to a cylinder block for an internal combustion engine, and more particularly relates to a cylinder block comprising a cylinder block housing and a crankcase.

### BACKGROUND

The publication DE 10 2008 029 026 A1 discloses an internal combustion engine having a bearing frame crankshaft bearing and having bearing block lateral insertions. The bearing frame is also referred to as the bedplate. In the known bearing frame crankshaft bearing, multiple first or upper plain bearing halves are arranged in a cylinder block housing and corresponding second or lower plain bearing halves are provided in a crankcase. To transmit lateral forces, the cylinder block housing has projections on both sides of the upper plain bearing halves, which protrude into corresponding recesses of the bearing frame or bedplate. For this purpose, a pair of opposing surfaces, which extend in the direction of a rotational axis of the crankshaft, of the projections and the recesses are implemented as fitting surfaces.

This arrangement of projections, which protrude out of the lower side of the cylinder block housing for the partition plane between cylinder block housing and crankcase, has the disadvantage that, for example, settling of the cylinder block housing loads and damages the projections because of the total weight of the cylinder block housing. The relatively light bearing frame or the bedplate is provided with depressions or recesses, which weakens this component at least in the area of the partition plane between the two plain bearing halves, particularly because the bearing frame having the lower plain bearing halves is already extremely filigree and complexly constructed.

At least one object herein is to provide a cylinder block having a cylinder block housing and crankcase that can be handled more robustly in the manufacturing sequence. In addition, other objects, desirable features and characteristics will become apparent from the subsequent summary and detailed description, and the appended claims, taken in conjunction with the accompanying drawings and this background.

### SUMMARY

A cylinder block for an internal combustion engine has a cylinder block housing and a crankcase. The cylinder block housing has a lower side, in which upper plain bearing halves are arranged. Lower plain bearing halves are arranged in a bearing frame of the crankcase. A partition plane, which aligns with a partition plane between the upper and the lower plain bearing halves, is arranged between the cylinder block housing and the crankcase. The bearing frame has, on both sides of the lower plain bearing halves, projections protruding beyond the partition plane, which protrude into recesses on the lower side of the cylinder block housing.

In an embodiment, the cylinder block has no additional recesses, which weaken the material, incorporated at least in the bedplate or in the bearing frame, which is arranged in a recess of the crankcase. Rather, projections are provided that protrude beyond the partition plane between the plain bearing halves, the partition plane between the plain bearing halves aligning with the partition plane between the cylinder block housing and the crankcase. The filigree bearing frame, in which the lower plain bearing halves of the crankshaft bearing are arranged, is additionally reinforced and stiffened in a practical manner by these protruding projections. Furthermore, in an embodiment, no projections protrude out of the lower side of the cylinder block housing, but rather recesses are provided in the lower side of the cylinder block housing into which the projections of the bearing frame of the crankcase protrude. Therefore, the lower side of the cylinder block housing remains completely flat in the area of the partition plane between the cylinder block housing and crankcase, and the cylinder block housing may thus be placed without problems on its flat lower side in the manufacturing sequence.

In a further embodiment, the projections of the bearing frame, which protrude beyond the partition plane, and the recesses on the lower side of the cylinder block housing can have interlocking inner edge sides, which center the upper and lower plain bearing halves to one another. This makes the final machining of the cylinder block to form a centered sequence of plain bearing bores made of upper and lower plain bearing halves easier.

Furthermore, it is provided that the interlocking inner edge sides of the recesses and the projections have a press fit. Heretofore typical adapter bores or adapter sleeves and corresponding adapter bolts may be replaced using this press fit and instead threaded bolts and corresponding bores can be provided, which have a clearance fit. This makes the installation or attachment of the bearing frame on the lower side of the cylinder block significantly easier and improves it, particularly because the introduction or remachining of a central bore for the mounting of the crankshaft between the plain bearing halves is made easier via the press fit of the interlocking inner edge sides.

In a further embodiment, it is provided that the projections of the bearing frame have a mesa structure having a partition plane to the cylinder block housing, which is arranged offset to a partition plane between the cylinder block housing and the crankcase. This offset can be less than the depth of the recesses to maintain a safe spacing gap between the ends of the projections and the base of the recesses.

A distance can be maintained between the partition plane of the mesa structure and the recesses on the lower side of the cylinder block housing so that the lower side of the cylinder block housing rests safely and reliably on an upper side of the bearing frame in the area of the partition plane after the assembly of the cylinder block.

In a further embodiment, the projections of the bearing frame protruding beyond the partition plane and the recesses on the lower side of the cylinder block housing have outer edge sides that are arranged overlapping at a distance from one another. In this regard, the overlapping, opposing outer edge sides of the projections of the bearing frame and the recesses on the lower side of the cylinder block housing do not have to be remachined after a fusion casting of the cylinder block housing and a fusion casting of the bearing frame. This saves machining time and machining costs, particularly because it is only important to have a reliable press fit or a reliable press seat between the inner edge sides of the interlocking projections and recesses.

Because of this press fit, it is now possible to dispense with the previous adapter bolts and adapter bores and to provide bores with clearance fit on the lower side of the cylinder block housing on both sides of the upper plain bearing halves, which merge into corresponding threaded bores. To fix the bearing frame on the lower side of the cylinder block housing, the bearing frame can also have bores having clearance fit on both sides of the lower plain bearing halves in which threaded bolts are arranged, which align with the bores on the lower side of the cylinder block housing. The threaded bolts have threads on their ends that engage with the threaded bores on the lower side of the cylinder block housing.

Furthermore, a metal alloy of the cylinder block housing can have a greater coefficient of thermal expansion than a metal alloy of the bearing frame. In this regard, the press fits of the inner edge sides, which contact one another, of the projections of the bearing frame and the recesses of the cylinder block housing also increase with increasing operating temperature of the cylinder block.

### BRIEF DESCRIPTION OF THE DRAWINGS

The various embodiments will hereinafter be described in conjunction with the following drawing figures, wherein like numerals denote like elements, and wherein:

FIG. 1 shows a schematic perspective view of a cylinder block housing having upper plain bearing halves of a crankshaft bearing according to an exemplary embodiment;

FIG. 2 shows a schematic perspective view of a crankcase having a bearing frame, which has lower plain bearing halves of the crankshaft bearing, in an exemplary embodiment; and

FIG. 3 shows a schematic cross-sectional view through the crankshaft bearing between the cylinder block housing and the crankcase, in an exemplary embodiment.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

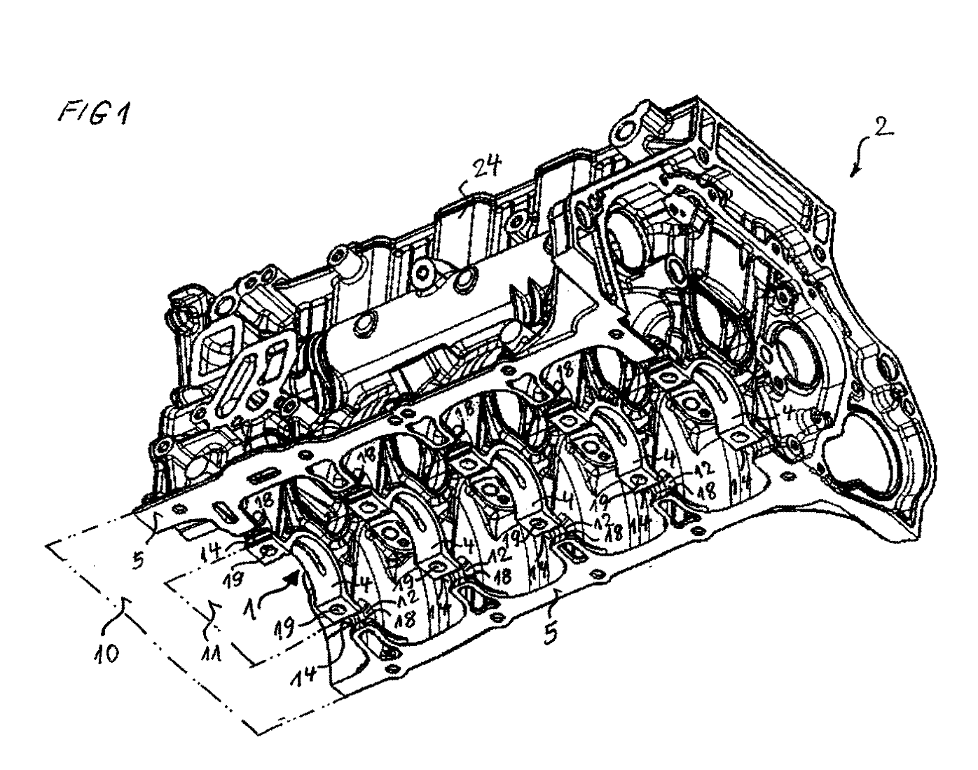

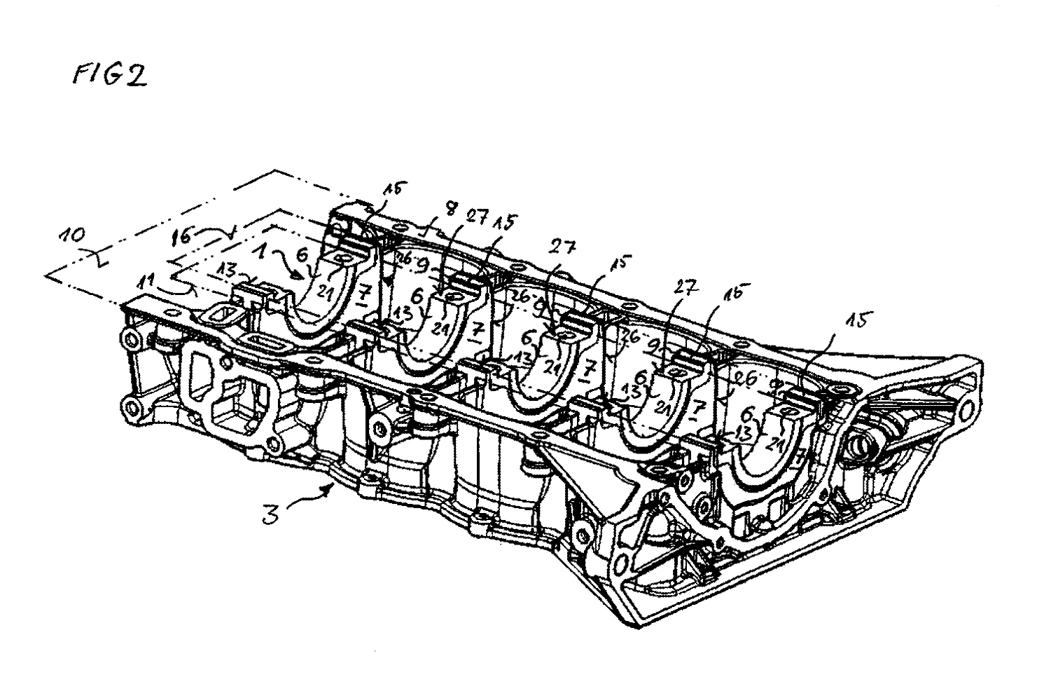

The cylinder block housing 2 shown in FIG. 1 has, on its lower side 5, five upper plain bearing halves 4, which are required for a crankshaft bearing 1 of a four-cylinder engine, for example. The lower side 5 of the cylinder block housing 2 is arranged in a partition plane 10 between the cylinder block housing 2 shown here and a crankcase 3 shown in FIG. 2. The cylinder block housing 2 and the crankcase 3 together form a cylinder block 24. Bores 19 are provided on both sides of the upper plain bearing halves 4 having a clearance fit, which merge into a threaded bore and are used to connect a bearing frame, which has lower plain bearing halves of a crankshaft bearing, to the upper plain bearing halves 4 shown here.

On both sides of the bores 19 having clearance fit shown here, recesses 12 are provided, which protrude into the lower side 5 of the cylinder block housing 2 and have inner edge sides 14, which cooperate with corresponding inner edge sides of projections of the bearing frame shown in FIG. 2 and form a mutually interlocking press fit upon attachment of the bearing frame. Therefore, complex adapter sleeves or adapter bolts can be dispensed with during the assembly of the cylinder block housing 2 shown here with the bearing frame shown in FIG. 2.

Furthermore, FIG. 1 shows that a partition plane 11 between the upper plain bearing halves 4 shown here and the lower plain bearing halves shown in FIG. 2 aligns with the partition plane 10 between the cylinder block housing 2 and the crankcase 3 and therefore neither projections nor other components protrude out of the lower side 5 of the cylinder block housing 2. The lower side 5 of the cylinder block housing 2 rather forms a flat surface which can be machined cost-effectively.

The crankcase 3 shown in FIG. 2 has, in a recess 26, a bearing frame 7, which in turn comprises lower plain bearing halves 6 of the crankshaft bearing 1. The partition plane 11 between the lower plain bearing halves 6 and the upper plain bearing halves, which aligns with the partition plane 10 between the cylinder block housing and the crankcase 3 shown here, is also visible in this FIG. 2. A partition plane 16 of a mesa structure 15, which is arranged offset, protrudes beyond these partition planes 10 and 11. The mesa structure 15 has projections 9. The projections 9 therefore protrude beyond an upper side 27 of the bearing frame and beyond an upper side 8 of the crankcase 3.

The projections 9 have inner edge sides 13, which are arranged on both sides of the lower plain bearing halves 6 and are aligned parallel to an axis of the crankshaft bearing. These inner edge sides 13 of the projections 9 correspond to the inner edge sides 14 of the recesses 12 shown in FIG. 1 and are dimensioned in such a manner that they have a press fit with one another. This press fit is reinforced still further upon heating of the cylinder block housing to operating temperature if the material of the cylinder block housing has a greater coefficient of thermal expansion than the material of the bearing frame 7. As FIG. 2 shows, this bearing frame 7 is a relatively filigree component, which is also additionally reinforced and stabilized by the projections 9.

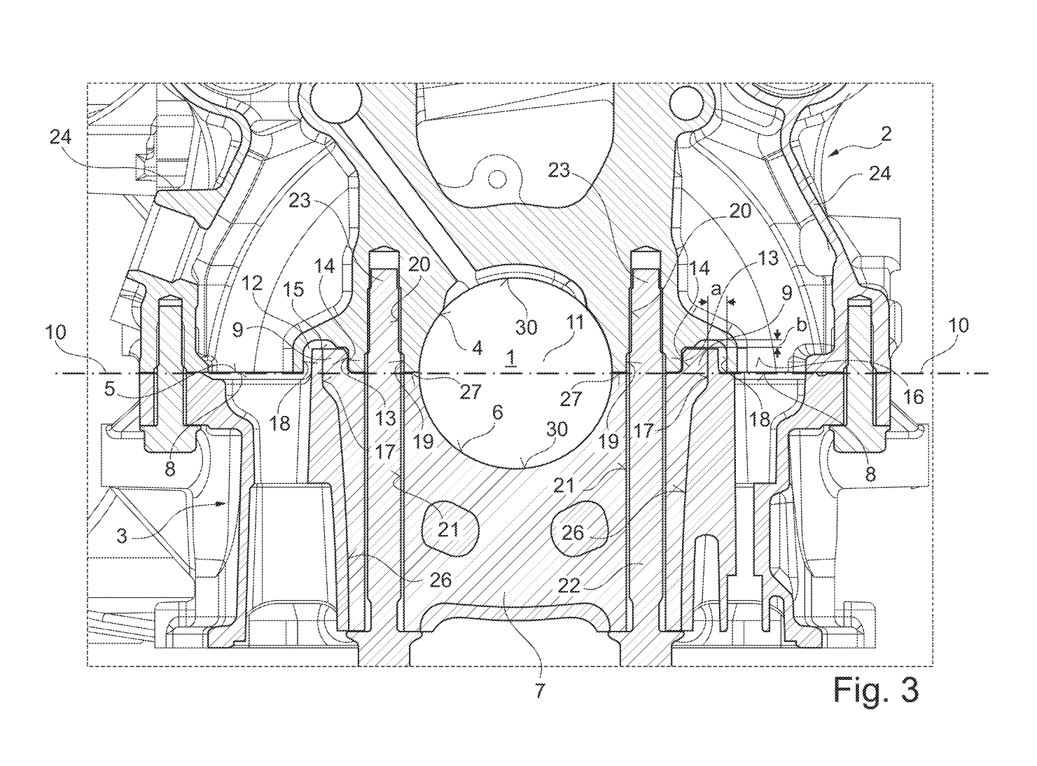

The schematic cross-sectional view in FIG. 3 through a crankshaft bearing 1 of the cylinder block 24 shows the assembly of the cylinder block housing 2 with the bearing frame 7, which is arranged in a recess 26 of the crankcase 3. A projection 9, which protrudes with its inner edge side 13 into recesses 12 on the lower side 5 of the cylinder block housing 2, protrudes out of the partition plane 11 between the upper plain bearing half 4 and the lower plain bearing half 6 on both sides.

The bearing frame 7 is held with the aid of threaded bolts 22, which protrude into the cylinder block housing 2. Threads at the end 23 of the threaded bolts 22 are engaged with the threaded bores 20 in the cylinder block housing 2. The threaded bolts 22 have a clearance fit in relation to the bores 19 in the lower side 5 of the cylinder block housing 2 and in relation to the bores 21 in the bearing frame 7, in particular the centering of the upper plain bearing halves 4 with the lower plain bearing halves 6 being achieved by a press fit between the inner edge sides 13 of the projections 9 and the inner edge sides 14 of the recesses 12.

As already mentioned above, this press fit can increase upon heating of the cylinder block 24, if the coefficient of thermal expansion of the cylinder block housing 2 is greater than the coefficient of thermal expansion of the bearing frame 7. While the inner edge sides 13 and 14 have this press fit, a relatively greater distance “a” is provided between outer edge side 18 of the recesses 12 and outer edge sides 17 of the projections 9, which makes the assembly easier. A further significant distance “b” is provided between the partition plane 16 of the mesa structure 15 and the inner ends of the recesses 12, in order to ensure a secure seat of the bearing frame 7 on the lower side 5 of the cylinder block housing 2 during finishing and smoothing of the plain bearing bores 30 in the crankshaft bearing 1.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

What is claimed is:

1. A cylinder block for an internal combustion engine, the cylinder block comprising:
a cylinder block housing;
a crankcase;
upper plain bearing halves arranged in the cylinder block housing toward a lower side of the cylinder block housing;
lower plain bearing halves arranged in a bearing frame toward an upper side of the crankcase;
a first partition plane between the cylinder block housing and the crankcase;
wherein the upper plain bearing halves have a second partition plane to the lower plain bearing halves, wherein the second partition plane aligns with the first partition plane between the cylinder block housing and the crankcase, and
wherein the bearing frame on both sides of the lower plain bearing halves has projections protruding beyond the second partition plane, the projections protruding into recesses on the lower side of the cylinder block housing.

2. The cylinder block housing according to claim 1, wherein the projections of the bearing frame, which protrude beyond the second partition plane, and the recesses on the lower side of the cylinder block housing have interlocking inner edge sides that center the upper plain bearing halves and the lower plain bearing halves to one another.

3. The cylinder block according to claim 2, wherein the interlocking inner edge sides of the recesses and the projections have a press fit.

4. The cylinder block according to claim 1, wherein the projections of the bearing frame have a mesa structure having a third partition plane to the cylinder block housing, which is arranged offset to the first partition plane between the cylinder block housing and the crankcase.

5. The cylinder block according to claim 4, wherein a distance is provided between the third partition plane of the mesa structure and the recesses on the lower side of the cylinder block housing.

6. The cylinder block according to claim 1, wherein the projections of the bearing frame, which protrude beyond the second partition plane, and the recesses on the lower side of the cylinder block housing have outer edge sides that are arranged overlapping at a distance from one another.

7. The cylinder block according to claim 1, wherein the lower side of the cylinder block housing, on both sides of the upper plain bearing halves, has bores with a clearance fit that merge into threaded bores.

8. The cylinder block according to claim 7, wherein the bearing frame, on both sides of the lower plain bearing halves, has bores having a clearance fit in which threaded bolts are arranged, which align with the bores on the lower side of the cylinder block housing, the threaded bolts having threads on their ends, that are engaged with the threaded bores on the lower side of the cylinder block housing.

9. The cylinder block according to claim 1, wherein a metal alloy of the cylinder block housing has a greater coefficient of thermal expansion than a metal alloy of the bearing frame.

10. An internal combustion engine having a cylinder block comprising:
a cylinder block housing;
a crankcase;
upper plain bearing halves arranged in the cylinder block housing toward a lower side of the cylinder block housing;
lower plain bearing halves arranged in a bearing frame toward an upper side of the crankcase;
a first partition plane between the cylinder block housing and the crankcase;
wherein the upper plain bearing halves have a second partition plane to the lower plain bearing halves, which aligns with the first partition plane between the cylinder block housing and the crankcase, and
wherein the bearing frame on both sides of the lower plain bearing halves has projections protruding beyond the second partition plane, the projections protruding into recesses on the lower side of the cylinder block housing.

11. The internal combustion engine according to claim 10, wherein the projections of the bearing frame, which protrude beyond the second partition plane, and the recesses on the lower side of the cylinder block housing have interlocking inner edge sides that center the upper plain bearing halves and the lower plain bearing halves to one another.

12. The internal combustion engine according to claim 11, wherein the interlocking inner edge sides of the recesses and the projections have a press fit.

13. The internal combustion engine according to claim 10, wherein the projections of the bearing frame have a mesa structure having a third partition plane to the cylinder block housing, which is arranged offset to the first partition plane between the cylinder block housing and the crankcase.

14. The internal combustion engine according to claim 13, wherein a distance is provided between the third partition plane of the mesa structure and the recesses on the lower side of the cylinder block housing.

15. The internal combustion engine according to claim 10, wherein the projections of the bearing frame, which protrude beyond the second partition plane, and the recesses on the lower side of the cylinder block housing have outer edge sides that are arranged overlapping at a distance from one another.

16. The internal combustion engine according to claim 10, wherein the lower side of the cylinder block housing, on both sides of the upper plain bearing halves, has bores with a clearance fit that merge into threaded bores.

17. The internal combustion engine according to claim 16, wherein the bearing frame, on both sides of the lower plain bearing halves, has bores having a clearance fit in which threaded bolts are arranged, which align with the bores on the lower side of the cylinder block housing, the threaded bolts having threads on their ends, that are engaged with the threaded bores on the lower side of the cylinder block housing.

18. The internal combustion engine according to claim 17, wherein a metal alloy of the cylinder block housing has a greater coefficient of thermal expansion than a metal alloy of the bearing frame.
